(19) United States
(12) Patent Application Publication
(10) Pub. No.: US 2021/0397786 A1
(43) Pub. Date: Dec. 23, 2021

(54) INFORMATION PROVIDING SYSTEM, INFORMATION PROVIDING METHOD, AND DATA STRUCTURE OF KNOWLEDGE DATA

(71) Applicant: Universal Entertainment Corporation, Tokyo (JP)

(72) Inventors: Takuo HENMI, Tokyo (JP); Junichi SATO, Tokyo (JP)

(21) Appl. No.: 17/287,613

(22) PCT Filed: Oct. 23, 2019
(86) PCT No.: PCT/JP2019/041485

§ 371 Date: Apr. 22, 2021

(30) Foreign Application Priority Data
Nov. 2, 2018 (JP) 2018-207170

(51) Int. Cl. G06F 40/247; G06F 16/332; G06N 5/04

(52) U.S. Cl. CPC G06F 40/247; G06N 5/04; G06F 16/3322

(57) ABSTRACT

A user is able to easily acquire desired knowledge data. An information providing system 1 stores a question text string associated with a response content, stores a synonym dictionary in which synonyms that are similar to one another in definition are set, receives an input text string input by a user by using a user terminal 100, generates a search text string by converting a term in the input text string based on the synonym dictionary, specifies a question text string related to the search text string, and sends the specified question text string to the user terminal 100.

### TECHNICAL FIELD

The present invention relates to an information providing system, an information providing method, and a data structure of knowledge data.

### BACKGROUND ART

A system that finds and returns optimal answers to users' questions has recently been actively researched. In connection with the development of such a system, studies have been carried out for natural language processing and artificial intelligence, in order to analyze the syntax and meaning of a question input by a user and to find an answer to a question.

For example, a question-answer system that outputs a candidate of an answer to a question, which is evaluated to be optimal, has been proposed (see Patent Literature 1). In this question-answer system, candidates of an answer to a question are found, a score indicating to what extent it is likely that each candidate is the right answer to the question is calculated by utilizing a learning function for each of combinations of the question and the candidates, and a candidate that is most likely to be the right answer to the question is output based on the calculated scores.

Meanwhile, there is a request content identification system which analyzes an input sentence that is a request from a user written in a natural language, determines whether the content of the request indicated by the input sentence corresponds to a content of a request defined in advance, and identifies and outputs the content of the request indicated by the input sentence (see Patent Literature 2).

### CITATION LIST

### Patent Literatures

[Patent Literature 1] Japanese Unexamined Patent Publication No. 2013-171550

[Patent Literature 2] Japanese Patent No. 5099367

### SUMMARY OF INVENTION

### Technical Problem

In the known systems described above, a user typically performs a search for a content of a question corresponding to a content of a request of the user, and selects a content of a question that seems to correspond to the content of the request, from search results. The known systems, however, are disadvantageous in that, when a content of a question that seems to correspond to the content of the request cannot be found in the first attempt, the user must repeatedly perform the search until a question that seems to correspond to the content of the request is listed in search results.

An object of the present invention is therefore to provide an information providing system and an information providing method by which a user is able to easily acquire desired knowledge data, and to provide a data structure of knowledge data.

### Solution to Problem

An information providing system of the present invention includes:

a knowledge data storage unit which is configured to store a question text string associated with a response content; a synonym storage unit which is configured to store a synonym dictionary in which synonyms that are similar to one another in definition are set;

a receiver which is configured to receive an input text string input by a user by using a user terminal;

a search unit which is configured to generate a search text string by converting a term included in the input text string based on the synonym dictionary, so as to specify the question text string related to the search text string; and a transmitter which is configured to send the specified question text string to the user terminal.

According to this arrangement, an input text string input by the user is converted to a search text string based on the synonym dictionary and a related question text string is specified. For this reason, a question text string including a specified synonym can be specified by normal search, and hence the possibility of acquiring a response content desired by the user is improved. A user is therefore able to easily acquire desired knowledge data.

The information providing system of the present invention may be arranged such that,

in the synonym dictionary, one of the synonyms is set as a representative term,

the knowledge data storage unit stores the question text string and a normalized text string generated by converting a term included in the question text string into a representative term based on the synonym dictionary, in association with each other,

the search unit generates a search text string by converting a term included in the input text string into a representative term based on the synonym dictionary, and

the search unit selects the normalized text string by using the search text string, so as to specify the question text string corresponding to the selected normalized text string.

According to this arrangement, the knowledge data storage unit is searched by using a search text string generated by converting a term in an input text string input by the user into a representative term based on the synonym dictionary. Because in the knowledge data storage unit a normalized text string generated by converting a question text string into a representative term based on the synonym dictionary is stored in association with the question text string, a term registered in the synonym dictionary is successfully listed in a search result, without requiring unification of terminology of question text strings in advance. This arrangement improves the possibility of providing more information regarding a question text string to a user as candidates of a response content desired by the user, as compared to a case where direct search is performed by using an input text string input by the user. For this reason, the user is able to easily obtain information of desired knowledge data.

The information providing system of the present invention may be arranged such that,

the user terminal confirms the input text string and sends the confirmed input text string to the receiver, each time an input is made by the user, and

the user terminal presents the question text string in a selectable manner, each time the question text string is supplied from the transmitter.

According to this arrangement, because the user terminal displays a question text string in real time and in a selectable manner each time an input is made by the user, it is possible to do away with a process of performing search and selecting a question text string, each time an input text string is updated.

The information providing system of the present invention may be arranged such that, in association with the representative term, the knowledge data storage unit stores a text string for input conversion, which corresponds to each of the synonyms.

According to this arrangement, because such a text string for input conversion is stored in the synonym dictionary, it becomes more likely to acquire a response content desired by the user only by specifying “Yomigana” or alphabets of a part of the synonym as an input text string.

An information provision control method of the present invention, which is executed by a computer including a storage unit, includes the steps of:

storing a question text string associated with a response content;

storing a synonym dictionary in which synonyms that are similar to one another in definition are set;

receiving an input text string input by a user by using a user terminal;

generating a search text string by converting a term included in the input text string based on the synonym dictionary, so as to specify the question text string related to the search text string; and

sending the specified question text string to the user terminal.

According to this arrangement, an input text string input by the user is converted to a search text string based on the synonym dictionary and a related question text string is specified. For this reason, a question text string including a specified synonym can be specified by normal search, and hence the possibility of acquiring a response content desired by the user is improved. A user is therefore able to easily acquire desired knowledge data.

A data structure of knowledge data of the present invention is used by a computer including a control unit accessible to a synonym storage unit storing a synonym dictionary in which synonyms that are similar to one another in definition are set, and is stored in a storage unit of the computer. The data structure including a structure in which a question text string is associated with a response content.

In regard to an input text string input by a user by using a user terminal, the control unit generates a search text string by converting a term included in an input text string based on the synonym dictionary, and specifies a question text string related to the search text string.

According to this arrangement, an input text string input by the user is converted to a search text string based on the synonym dictionary and a related question text string is specified. For this reason, a question text string including a specified synonym can be specified by normal search, and hence the possibility of acquiring a response content desired by the user is improved. A user is therefore able to easily acquire desired knowledge data.

### Advantageous Effects

A user is able to easily acquire desired knowledge data.

### BRIEF DESCRIPTION OF DRAWINGS

FIG. 1 illustrates the outline of an information providing system.

FIG. 2 is a block diagram of the electrical configuration of the information providing system.

FIG. 3 is a functional block diagram of the information providing system.

FIG. 4 illustrates a knowledge data table.

FIG. 5 illustrates a synonym dictionary data table.

FIG. 6 illustrates a suggestion data table.

FIG. 7 is a flowchart of a suggestion data registration process.

FIG. 8 is a flowchart of a question-answer process.

FIG. 9 illustrates a modification of an input screen of a user terminal.

FIG. 10 is a flowchart of a question-answer request process.

FIG. 11 illustrates a modification of the synonym dictionary data table.

FIG. 12 illustrates a modification of the input screen of the user terminal.

### DESCRIPTION OF EMBODIMENTS

The following will describe an information providing system of the present invention with reference to figures.

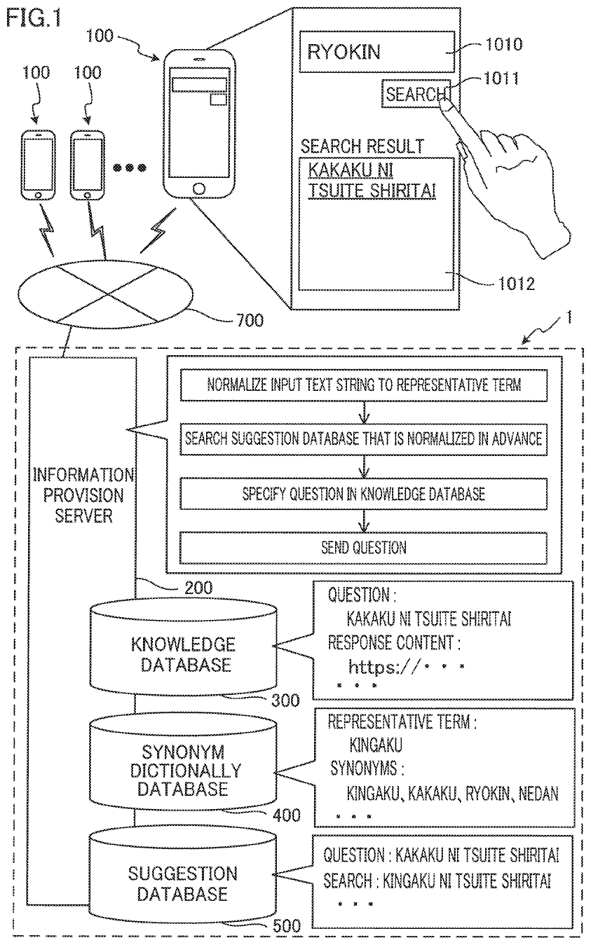

As shown in FIG. 1, an information providing system 1 of an embodiment includes an information provision server 200 which is able to perform data communication with a user terminal 100 over a network 700 including the Internet. According to a non-limiting example, the information providing system 1 of the present embodiment is constituted by the information provision server 200. Below-described functions of the information provision server 200 may be provided at plural servers in a dispersed manner by the information providing system 1. In other words, each function of the information provision server 200 may be provided in a component of the information providing system. The following will describe the information provision server 200 functioning as the information providing system 1.

In the user terminal 100, a web browser for accessing services provided by the information providing system 1 is installed. In other words, users access the information providing system 1 through the web browser. While the user terminal 100 is a so-called smartphone in the present embodiment, it may be a mobile computer or a desktop computer. Examples of the mobile user terminal 100 include mobile information devices such as a portable computer, a laptop computer, a tablet PC, a wearable PC, and a PDA (Personal Data Assistant).

A user inputs, for example, a text string by using a keyboard or a touch panel into an input area 1010 displayed in a website on the information providing system 1 through the web browser executed by the user terminal 100. The user then touches, for example, a search button 1011 in the same website by using a mouse or a touch panel. As a result, the input text string input by the user is sent to the information provision server 200 as a request.

In the present embodiment, the search button 1011 is pressed to send the input text string from the user terminal 100. The disclosure, however, is not limited to this arrangement. For example, each time a text input to the input area 1010 is changed, the text in the input area 1010 may be sent to the information providing system 1 as an input text string on the background.

The input text string input by the user is typically a sentence (input text). The input text string includes, for example, a question about a product of a company that owns the website including the web page, and is expressed in a natural language. Hereinafter, an input from a user may be referred to as an input text. An input text string may not be a sentence, and may be one of various types of input text strings including words or part of a sentence.

Upon receiving an input text string from the user terminal 100, the information provision server 200 determines a question text string corresponding to this input text string, and sends the question text string to the user terminal 100 over the network 700. The user terminal 100 displays, in a screen in a search result area 1012, the question text string sent from the information provision server 200. The question text string displayed in the result area 1012 is a link to a URL of a website showing a response content corresponding to the question text string. The user is therefore able to recognize the response content corresponding to the question text string by specifying the question text string.

Each time a text input to the input area 1010 is changed, the text in the input area 1010 may be sent to the information providing system 1 as an input text string on the background. In this connection, preferably, a question text string corresponding to the text in the input area 1010 is displayed in a selectable manner in real time, without screen transition.

As such, the information provision server 200 is allowed to access knowledge data in which a response content is associated with a question text string. To put it differently, the information provision server 200 is able to provide, to the user terminal 100, information for accessing a response content corresponding to a specified question text string.

To be more specific, the information provision server 200 includes a knowledge database 300, a synonym dictionary database 400, and a suggestion database 500. The knowledge database 300 as a knowledge data storage unit stores knowledge database in which a response content is associated with each question text string. When sending information for accessing a response content corresponding to a specified question text string to the user terminal 100, the information provision server 200 refers to the knowledge database 300. For example, when the user specifies a question text string “Kakaku Ni Tsuite Shiritai (I want to know about fee)”, the information provision server 200 provides a response content “Kakaku Ha XX Desu (Fee is XX)” corresponding to the question text string to the user with reference to the knowledge database 300.

The synonym dictionary database 400 as a synonym storage unit stores a synonym dictionary in which synonyms that are similar to one another in definition are set. For example, as data of synonym of one term, which are similar to one another in definition, sets of information indicating “Kingaku (cost)”, “Kakaku (fee)”, “Ryokin (amount)”, and “Nedan (price)” are included. The synonym dictionary database 400 stores plural sets of synonyms.

In the synonym dictionary stored in the synonym dictionary database 400, one of synonyms may be set as a representative term. To put it differently, a representative term is information of one of terms that are similar to one another in definition and are set as synonyms. As such, the synonym dictionary database 400 stores a synonym dictionary in which one of synonyms is set as a representative term. In other words, one set of data stored in the synonym dictionary database 400 is a set of data including information of synonyms and information indicating that one of the synonyms is a representative term. For example, the synonym dictionary database 400 stores information indicating “Kingaku (cost)”, “Kakaku (fee)”, “Ryokin (amount)”, and “Nedan (price)” and information indicating that “Kingaku (cost)” is set as a representative term among thee terms. The information provision server 200 refers to the synonym dictionary database 400 when converting a question text string to a normalized text string. The information provision server 200 also refers to the synonym dictionary database 400 when converting an input text string from the user to a search text string.

When synonyms are written in Chinese characters, Yomigana which indicates the pronunciation of the characters may be registered in the synonym dictionary database 400. When a text is input in a language written by using Chinese characters, Yomigana is typically specified by, for example, a combination of alphabets, and the Yomigana is converted to Chinese characters and the input is confirmed. Because Yomigana of each synonym is registered, an input text string from the user can be converted to a search text string even if the input is confirmed without converting Yomigana to Chinese characters or before Yomigana is converted to Chinese characters.

The suggestion database 500 stores a question text string and a normalized text string in association with each other. The normalized text string is generated by converting a tern included in the question text string into a representative term based on the synonym dictionary in the synonym dictionary database 400. Hereinafter, normalization indicates conversion of a term included in a text string, which is included in synonym registered in the synonym dictionary database 400, into a representative term set among the synonyms. For example, when a question text string includes “Kakaku”, “Ryokin”, and “Nedan”, these terms are all converted to “Kingaku” by normalization and registered in the suggestion database 500. For example, when a question text string is “Kakaku Ni Tsuite Shiritai (I want to know about fee)”, the normalized text string is “Kingaku Ni Tsuite Shiritai (I want to know about cost).

A “question text string” stored in the suggestion database 500 is not limited to a question text string per se, and may be information indicating which type of data stored in the knowledge database 300 the question text string is. For example, when a question text string registered in the knowledge database 300 is specified by a unique key, the unique key is associated with a normalized text string in the suggestion database 500. In the suggestion database 500, Yomigana indicating pronunciation of a question text string or a normalized text string may be registered.

Association between a question text string and a normalized text string stored in the suggestion database 500 may be stored in the knowledge database 300. In other words, the knowledge database 300 may store a question text string with which a response content is associated, and a normalized text string in which a term included in the question text string is converted to a representative term with reference to the synonym dictionary may be associated with the question text string and stored.

The information provision server 200 including the databases 300, 400, and 500 receives an input text string input by the user by using the user terminal 100, generates a search text string by converting a term included in the input text string based on the synonym dictionary, specifies a question text string related to the search text string, and sends the specified question text string to the user terminal 100.

As shown in FIG. 1, in the present embodiment, the information provision server 200 receives an input text string input to the user terminal 100, converts the input text string to a search text string based on a synonym dictionary in the synonym dictionary database 400, selects a normalized text string in the suggestion server 500 by using the search text string, specifies a question text string corresponding to the selected normalized text string, and sends the specified question text string to the user terminal 100.

As such, an input text string input by a user is normalized to a search text string based on the synonym dictionary database 400, and the suggestion database 500 is searched by using this search text string. Because in the suggestion database 500 a normalized text string generated by normalizing a question text string is stored in association with the question text string, a term registered in the synonym dictionary database 400 is successfully listed in a search result, without requiring unification of terminology of question text strings in advance. This arrangement improves the possibility of providing more information for a question text string to a user as candidates of a response content desired by the user, as compared to a case where the knowledge data is directly searched by using an input text string input by the user. For this reason, the user is able to easily obtain information of desired knowledge data.

Alternatively, for example, one or more search text string corresponding to an input text string from the user terminal 100 may be generated based on the synonym dictionary, and the knowledge database 300 as the knowledge data storage unit may be searched by using the one or more search text string. As such, an input text string input by the user is converted to a search text string based on the synonym dictionary and a related question text string is specified. For this reason, a question text string including a specified synonym can be specified by normal search, and hence the possibility of acquiring a response content desired by the user is improved.

To put it differently, a data structure of knowledge data is used by a computer including a control unit accessible to the synonym database 400 storing the synonym dictionary in which synonyms that are similar to one another in definition are set, and the data structure is stored in a storage unit of the computer. The data structure of the knowledge data includes a structure in which a question text string is associated with a response content. In regard to an input text string input by the user by using a user terminal, the control unit generates a search text string by converting a term included in the input text string based on the synonym dictionary, and specifies the question text string related to the search text string.

In addition, the data structure of information provision search data registered in the suggestion database 500 includes a structure in which a question text string is associated with a normalized text string. In the normalized text string, each term in the question text string are converted to a representative term based on the synonym dictionary database 400 in which one of synonyms is set as a representative term. Thanks to this data structure, the information provision search data allows the information provision server 200 to search the suggestion database 500 for a normalized text string by using a search text string generated by converting each term in an input text string input to the user terminal 100 by a user into a representative term based on the synonym dictionary database 400, and to specify a question text string based on a search result.

As described above, the data structure includes a structure in which a question text string is associated with a normalized text string generated by normalizing the question text string based on the synonym dictionary database 400. Based on this data structure, the following processes are realized: a searching process of searching the data structure for a normalized text string by using a search text string generated by normalizing an input text string input by a user; and a specifying process of specifying a question text string. This arrangement improves the possibility of providing more information regarding a question text string to a user as candidates of a response content desired by the user, as compared to a case where the knowledge data is directly searched by using an input text string input by the user. For this reason, the user is able to easily obtain information of desired knowledge data.

When the information providing system 1 is provided as a system available for unspecified users, the users are assumed to be general users who ask questions to a company or organization that provides the website (about products, services, and so on). The user terminal 100 is typically a PC (Personal Computer) connectable to the Internet, etc. and owned by a user. The information providing system 1 may be used as a system used within a limited area (e.g., an intra-organizational knowledge sharing system). In this case, the users are specific users who have valid permission to access the information providing system 1.

Management operations such as the construction of the above-described database and the addition of data are performed by a system administrator of the information providing system 1. When the information providing system 1 is used as a system for answering questions regarding products, services, and so on of a company or an organization, a person in charge of that company or organization typically acts as the system administrator. Alternatively, an agency or a trustee company may act as the system administrator on behalf of the company or organization.

In FIG. 1, a user sends a question, etc. to the information providing system 1 by inputting a text string into an input area of a website by using a keyboard, etc. In this connection, the method and route of providing a text string to the information providing system 1 are not limited. For example, when a user verbally asks a question, the voice is converted to a text string by means of speech recognition, and the text string is sent to the information providing system 1. Furthermore, a printed question, etc. may be converted to a text string by means of optical character recognition (OCR), and the text string is sent to the information providing system 1.

The information provision server 200 of the present embodiment has a function as a web server which sends and receives data under a protocol such as http and by using a web browser run at the user terminal 100 and an unillustrated terminal of the system administrator, and displays a predetermined web page on the web browser. While the information provision server 200 is a single computer in the embodiment, the information provision server 200 may be embodied in such a way that the functions of this server are executed by plural computers in a dispersed manner. In this case, these computers (server) constitute the information providing system 1.

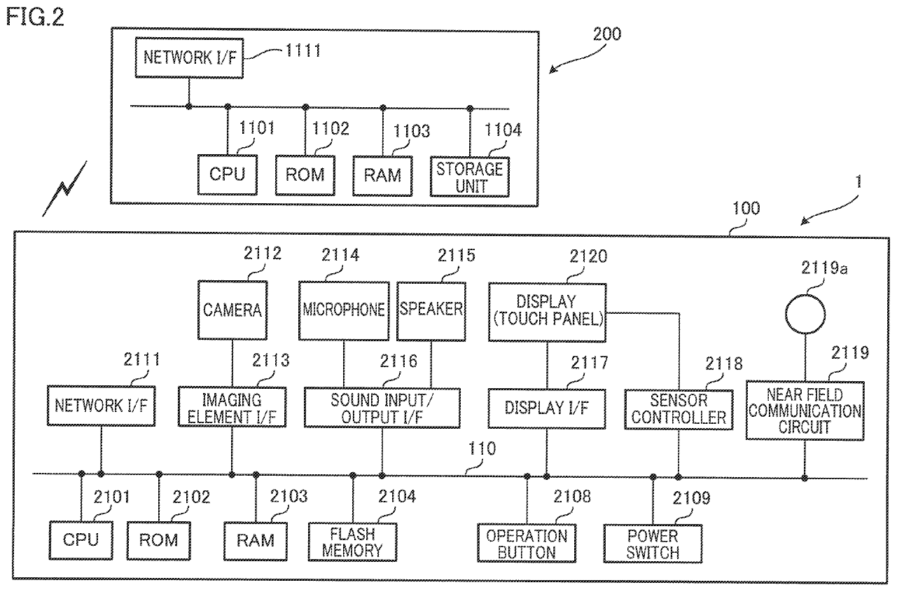

As shown in FIG. 2, the user terminal 100 includes, in a housing, a CPU 2101, a ROM 2102, a RAM 2103, a flash memory 2104, an operation button 2108, a power switch 2109, a bus line 2110, a network I/F 2111, a camera 2112, an imaging element I/F 2113, a microphone 2114, a speaker 2115, a sound input/output I/F 2116, a display I/F 2117, a sensor controller 2118, a near field communication circuit 2119, and an antenna 2119a of the near field communication circuit 2119.

Further, the information provision server 200 is a so-called computer including a CPU 1101, a ROM 1102, a RAM 1103, a storage device 1104 such as a hard disk drive and the like, and a network I/F 1111.

The CPU (Central Processing Unit) 2101 functions as a main structure of the controller in the user terminal 100, and controls the entire operation of the user terminal 100. The CPU 1101 functions as a main structure of the control unit in the information provision server 200, and controls the entire operation of the information provision server 200. In other words, the CPU 1101 functions as a controller controlling the entire operation of the information providing system 1. The ROM (Read Only Memory) 2102 stores programs used for driving the CPU 2101, such as an IPL (Initial Program Loader).

The RAM (Random Access Memory) 2103 and the RAM 1103 are used as a work area of the CPU 2101 and the CPU 1101. The operation button 2108 is used for, for example, initial setting of the user terminal 100. The power switch 2109 is used for turning ON/OFF the power source of the user terminal 100.

The flash memory 2104 serving as the memory is a non-volatile computer readable medium which stores a program such as a web browser, a program for communication, and plural sets of data such as image data and sound data. The storage device 1104 is a non-volatile computer readable medium which stores the above-described databases. In response to a request from an application such as the web browser of the user terminal 100, the information provision server 200 returns as needed a response referring to the database in the storage device 1104.

For example, the storage device 1104 stores various programs including a program executed by the CPU 1101 serving as a controller, and various data used in the various programs. In other words, the program causes the information provision server 200 to execute processes which are included by various programs. The information provision server 200 is a computer which includes the CPU 1101 and the storage device 1104. When the information provision server 200 is regarded as the information providing system 1, the storage device 1104 stores various programs including a program executed by the CPU 1101 serving as a controller, and various data used in the various programs. In other words, the program causes the information provision server 200 to execute processes which are included by various programs. The information provision server 200 is the information providing system 1 which includes the CPU 1101 and the storage device 1104. As such, the processes and operations of the information providing system 1 can be interpreted as those of a game program or an information providing method.

The data and program in the flash memory 2104 and the storage device 1104 may be stored in advance at the stage of factory shipment, or may be downloaded from an unillustrated server or the like via communication means and then stored. The communication means may be an interactive communication passage such as the Internet and a cable TV, or may be one-way broadcasting. Alternatively, the data and program stored in the memory flash memory 2104 and the storage device 1104 may be stored in a recording medium such as a floppy disk, a CD-ROM, a DVD-ROM, an MO (optical magnetic disc), and a flash memory, and may be read from the recording medium and installed in the memory according to need.

The network I/F (Interface) 2111 and the network I/F 1111 are each an interface for data communications using a communication network such as the internet. The camera 2112 is a built-in camera image capturing means which captures an image of an object to obtain image data under the control of the CPU 101. The imaging element I/F 2113 is a circuit for controlling the camera 2112. The microphone 2114 is a built-in sound collection means to which sound is input. The sound input/output I/F 2116 is a circuit for processing input and output of a sound signal between the microphone 2114 and the speaker 2115 under the control of the CPU 101. The display I/F 2117 is a circuit for sending image data to the display 2120 under the control of the CPU 2101. The display 2120 is provided on the front surface of the housing. The sensor controller 2118 is a circuit for receiving an input from the touch panel of the display 2120. The near field communication circuit 2119 is a communication circuit based on NFC (Near Field Communication) (Registered Trademark). Bluetooth (Registered Trademark), or the like. The bus line 2110 is an address bus, a data bus, or the like for electrically connecting the components such as the CPU 101.

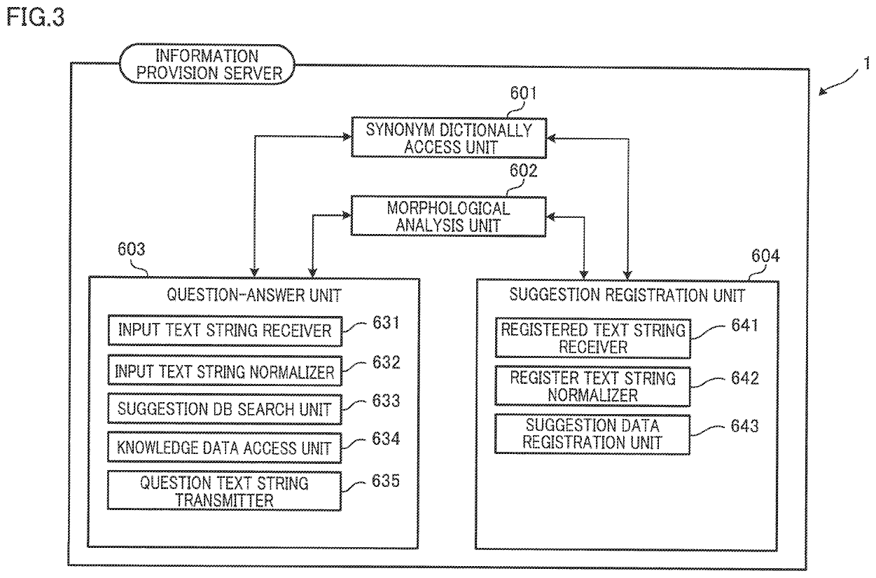

As shown in FIG. 3, the information providing system 1 has the following functions. To be more specific, the information providing system 1 includes a synonym dictionally access unit 601, a morphological analysis unit 602, a question-answer unit 603, and a suggestion registration unit 604.

The synonym dictionally access unit 601 has a function of accessing the synonym dictionary database 400 when a text string is normalized by a representative term. The morphological analysis unit 602 has a function of dividing a text string into minimum units. To be more specific, the morphological analysis unit 602 has a function of performing morphological analysis of an input text string from the user terminal 100 and sampling terms which are to be converted to representative terms. Various known methods can be used to perform the morphological analysis.

The question-answer unit 603 has a function of sending a question text string and/or information indicating a response content to the user terminal 100, based on an input text string sent from the user terminal 100. To be more specific, the question-answer unit 603 includes an input text string receiver 631, an input text string normalizer 632, a suggestion DB search unit 633, a knowledge data access unit 634, and a question text string transmitter 635.

The input text string receiver 631 has a function of receiving an input text string from the user terminal 100 and a function of transmitting the input text string to the input text string normalizer 632. The input text string normalizer 632 has: a function of sending an input text string from the input text string receiver 631 to the morphological analysis unit 602 and receiving a result of morphological analysis from the morphological analysis unit 602; a function of sampling a term which must be converted to a representative term from the result of the morphological analysis; a function of sending the term to the synonym dictionally access unit 601 and receiving a representative term after conversion from the synonym dictionally access unit 601; a function of generating a search text string generated by converting the input text string based on the received representative term; and a function of sending the search text string to the suggestion DB search unit 633. The suggestion DB search unit 633 has: a function of searching the suggestion database 500 for a normalized text string by using a search text string; and a function of sending a search result for specifying a question text string to the knowledge data access unit 634. The knowledge data access unit 634 has: a function of specifying a question text string and/or information indicating a response content with reference to the knowledge database 300 based on the search result; and a function of sending the specified question text string and/or the information indicating the response content to the question text string transmitter 635. The question text string transmitter 635 has a function of sending a question text string and/or information indicating a response content to the user terminal 100.

The suggestion registration unit 604 has a function of registering a question text string and a normalized text string in association with the suggestion database 500. To be more specific, the suggestion registration unit 604 includes a registered text string receiver 641, a register text string normalizer 642, and a suggestion data registration unit 643. The registered text string receiver 641 has a function of receiving a registered text string from an administration terminal of an unillustrated administrator. The registered text string is a question text string registered in the knowledge database 300. When a question text string is associated with a unique key in the knowledge database 300, the registered text string receiver 641 receives the unique key from the administration terminal and receives the question text string from the knowledge database 300 based on the unique key. In other words, the registered text string receiver 641 may have a function of accessing the knowledge database 300. The register text string normalizer 642 has: a function of sending a received question text string to the morphological analysis unit 602 and receiving a result of morphological analysis from the morphological analysis unit 602; a function of sampling a term which must be converted to a representative term from the result of the morphological analysis; a function of sending the term to the synonym dictionally access unit 601 and receiving a representative term after conversion from the synonym dictionally access unit 601; a function of generating a normalized text string generated by converting the question text string based on the received representative term; and a function of sending the normalized text string in the suggestion data registration unit 643. The suggestion data registration unit 643 has: a function of receiving a normalized text string from the register text string normalizer 642; and a function of registering the normalized text string in the suggestion database 500 in association with either a question text string or a unique key that indicates a question text string.

While in the present embodiment processes and operations described below presuppose that the information provision server 200 has the functions described above, the functions may be distributed to the components of the information providing system 1. The above-described functions of the information providing system 1 may be embodied as an additional module of another system.

The following will describe examples of data tables in the knowledge database 300, the synonym dictionary database 400, and the suggestion database 500 stored i the information provision server 200.

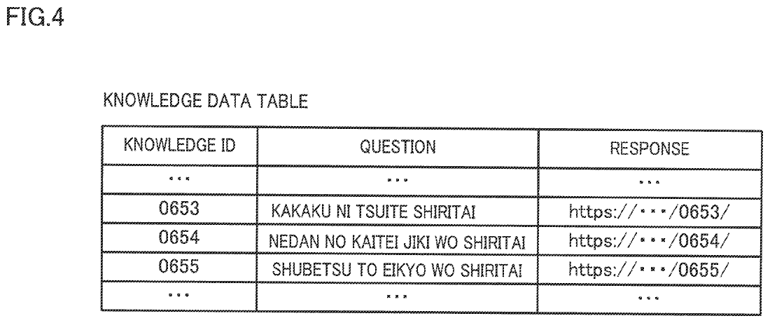

As shown in FIG. 4, the knowledge data table includes a knowledge ID column, a question column, and a response column. The knowledge ID column stores unique keys by which questions are identified. The question column stores question text strings that are presented to users. The response column stores URLs of websites showing responses corresponding to question text strings. Response contents responding to question text strings may directly stored in the response column.

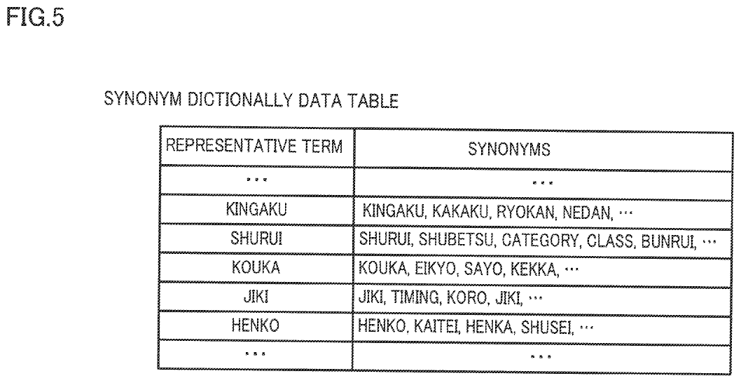

As shown in FIG. 5, the synonym dictionary data table includes a representative term column and a synonym column. The representative term column stores one term selected from each group of synonyms. The synonym column stores, in association with a representative term, a group of synonyms including the representative term. The group of synonyms may not include the representative term. A synonym dictionally data table is referred to when a text string is normalized.

For example, a representative term of a group of synonyms “Kingaku”, “Kakaku”, “Ryokin”, and “Nedan” is “Kingaku”. On this account, when a question text string including one or more of these synonyms is normalized and converted to a normalized text string, or when an input text string including one or more of these synonyms is normalized and converted to a search text string, the synonyms are all converted to “Kingaku”.

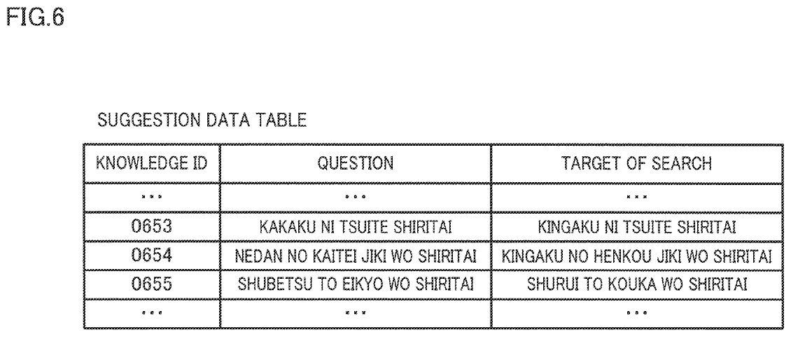

As shown in FIG. 6, the suggestion data table includes a knowledge ID column, a question column, and a search target column. The knowledge ID column stores unique keys by which questions are identified. The question column stores question text strings that are presented to users. The search target column stores normalized text strings generated by normalizing corresponding question text strings.

For example, when a question text string is “Kakaku Ni Tsuite Shiritai (I want to know about price)”, the synonym data table (see FIG. 5) in the synonym database 400 is referred to, and a normalized text string “Kingaku Ni Tsuite Shiritai” in which “Kakaku” is normalized to “Kingaku” which is a representative term is generated. When a question text string is “Nedan No Kaitei Jiki Wo Shiritai (I want to know when price is revised)”, a normalized text string “Kingaku No Henkou Jiki Wo Shiritai” is generated by converting “Nedan” to “Kingaku” which is a representative term and converting “Kaitei (revision)” to “Henkou” which is a representative term. In this regard, the term “Jiki (timing)” is a representative term and is therefore not converted.

The following will describe a program run by the CPU 1101 of the information provision server 1.

The following will describe a suggestion data registration process executed by the CPU 1101 of the information provision server 1.

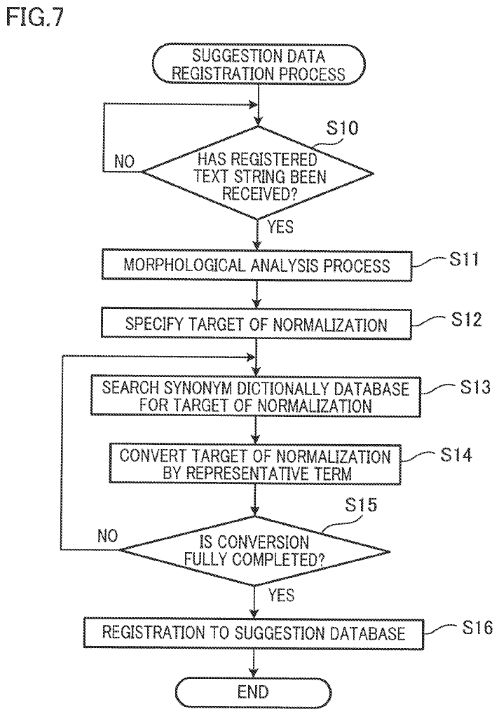

As shown in FIG. 7, to begin with, the CPU 1101 determines whether a registered text string has been received (S10). When a registered text string has not been received (NO in S10), the CPU 1101 repeatedly executes the step S10 and waits for a registered text string. When a registered text string has been received (YES in S10), the CPU 1101 performs a morphological analysis process for the received registered text string (S11). The CPU 1101 then specifies a term which is to be normalized in the registered text string (S12). For example, the CPU 1101 specifies the part-of-speech of each morpheme by morphological analysis, and morphemes that are specified as a common noun or a sateen-noun are selected as targets of normalization.

The CPU 1101 then searches the synonym column of the synonym dictionary database 400 for a morpheme which is regarded as a target of normalization (S13). The CPU 1101 then converts the morpheme regarded as a target of normalization to a corresponding representative term (S14). Although not illustrated, when a morpheme which is a target of normalization is not stored in the synonym column, the CPU 1101 does not perform conversion and proceeds to the step S15.

The CPU 1101 then determines whether conversion of all morphemes in the received registered text string, which are regarded as targets of normalization, has been completed (S15). When the conversion of all morphemes has not been completed (NO in S15), the CPU 1101 proceeds to the step S13. When the conversion has been completed (YES in S15), the CPU 1101 registers the registered text string having been converted in the suggestion database 500 as a normalized text string (S16), and ends the routine.

The routine may be automatically executed when the knowledge database 300 is constructed or updated. For example, after a process of constructing or updating an unillustrated knowledge database 300, the routine may be automatically executed for all question text strings or updated question text strings in the knowledge database 300.

The following will describe a question-answer process executed by the CPU 1101 of the information provision server 1.

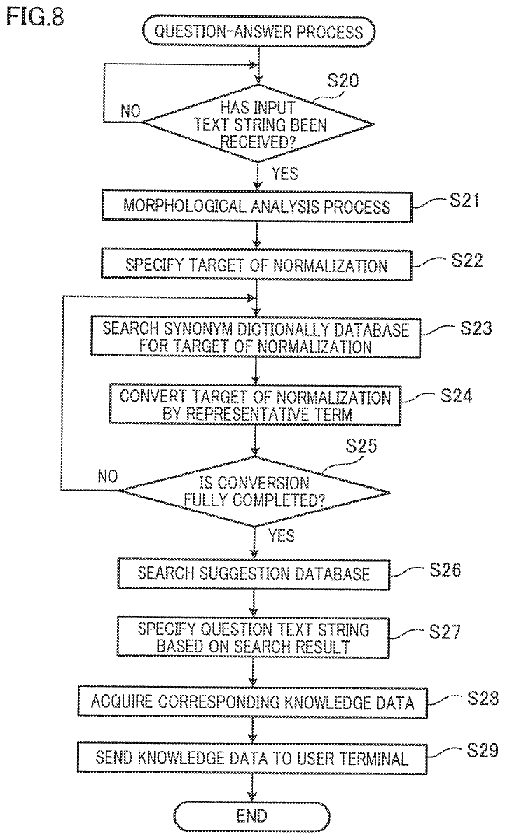

As shown in FIG. 8, to begin with, the CPU 1101 determines whether an input text string has been received (S20). When an input text string has not been received (NO in S20), the CPU 1101 repeatedly executes the step S20 and waits for an input text string. When an input text string has been received (YES in S20), the CPU 1101 performs a morphological analysis process for the received input text string (S21). The CPU 1101 then specifies a term which is to be normalized in the input text string (S22). For example, the CPU 1101 specifies the part-of-speech of each morpheme by morphological analysis, and morphemes that are specified as a common noun or a sateen-noun are selected as targets of normalization.

The CPU 1101 then searches the synonym column of the synonym dictionary database 400 for a morpheme which is regarded as a target of normalization (S23). The CPU 1101 then converts the morpheme regarded as a target of normalization to a corresponding representative term (S24). For example, when an input text string is “Ryokin”, the input text string is converted to “Kingaku” which is a representative term of the group of synonyms including “Kingaku”. Although not illustrated, when a morpheme which is a target of normalization is not stored in the synonym column, the CPU 1101 does not perform conversion and proceeds to the step S15.

The CPU 1101 then determines whether conversion of all morphemes in the received input text string, which are regarded as targets of normalization, has been completed (S25). When the conversion of all morphemes has not been completed (NO in S25), the CPU 1101 proceeds to the step S23. When the conversion has been completed (YES in S25), the CPU 1101 searches the suggestion database 500 by using the converted terms as search text strings (S26). Although not illustrated, when a morpheme which is regarded as a target of normalization is not included in the synonym column, the CPU 1101 searches the suggestion database 500 by using a text string identical with the morpheme regarded as the target of normalization.

In the present embodiment, when there are plural terms generated by conversion, AND search is performed by these terms. Alternatively, OR search may be performed by the terms.

The CPU 1101 then specifies a question text string based on a normalized text string listed in a search result (S27), and acquires knowledge data corresponding to the question text string from the knowledge database 300 (S28). The CPU 1101 then sends the acquired knowledge data to the user terminal 100 (S29) and ends the routine. Although not illustrated, when a relevant normalized text string is not listed in a search result, the CPU 1101 sends, to the user terminal 100, information indicating that there is no relevant knowledge data.

The embodiment of the present invention thus described above solely serves as specific examples of the present invention, and is not to limit the scope of the present invention. The specific structures and the like are suitably modifiable. Further, the effects described in the embodiment of the present invention are no more than examples of preferable effects brought about by the present invention, and the effects of the present invention are not limited to those described hereinabove.

### (Modification 1)

As shown in FIG. 1, in the embodiment above, an input text string is confirmed as the search button 1011 is pressed. In a modification below, an input text string is confirmed each time a user updates the input text string.

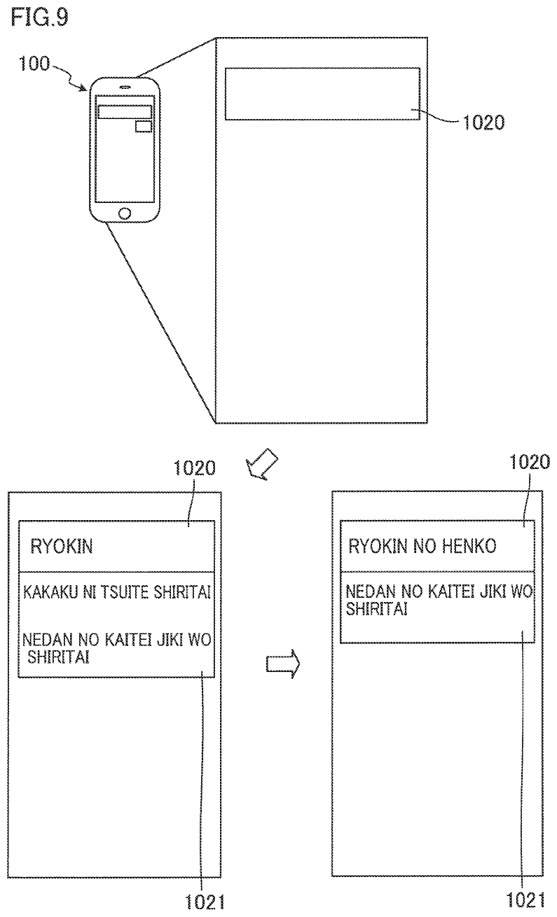

To be more specific, as shown in FIG. 9, an input screen displayed on the user terminal 100 has an input area 1020. Each time the user inputs a part of an input text string in the input area 1020, a question text string of knowledge data corresponding to the input text string is displayed in a selectable manner in a suggested keyword area 1021 below the input area 1020, as a suggested keyword. The suggested keyword area 1021 is viewable without requiring screen transition from the input screen.

The following will describe a question-answer request process executed by a CPU 2101 of the user terminal 100. A program of the question-answer request process run by the user terminal 100 is downloaded such that the user terminal 100 accesses a website hosted by the information providing system 1 through a web browser. To be more specific, the program of the question-answer request process is a script directly or indirectly embodied in HTML of the website.

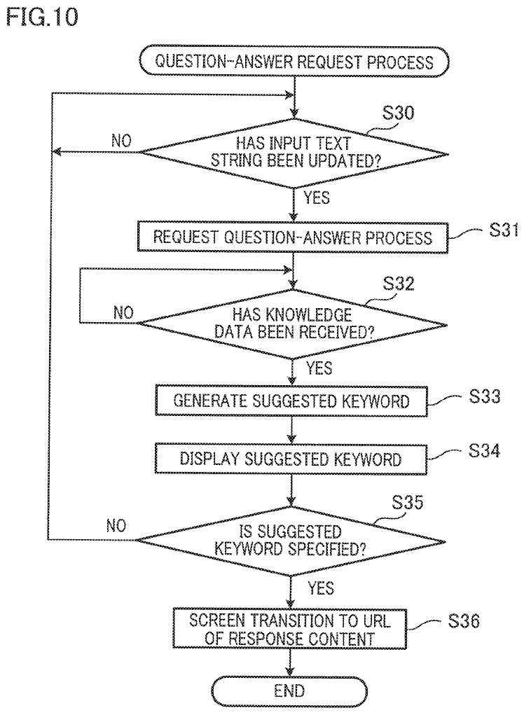

As shown in FIG. 10, to begin with, the CPU 2101 determines whether an input text string in the input area 1020 has been updated (S30). When the input area 1020 has not been updated (NO in S30), the CPU 2101 repeatedly executes the step S30 and waits for the update of the input text string in the input area 1020. When the input area 1020 has been updated (YES in S30), a request for performing a question-answer process is sent to the information provision server 200 (S31).

The CPU 2101 then determines whether a response including knowledge data has been supplied from the information provision server 200 (S32). When the response has not been supplied (NO in S32), the CPU 2101 repeatedly executes the step S32 and waits for the response. Although not illustrated, when an input text string in the input area 1020 is updated while the response is waited for, the CPU 2101 proceeds to the step S31 and ignores the response that is waited for.

When the response has been supplied (YES in S32), the CPU 2101 generates, as a suggested keyword, a question text string including a link to a URL indicating a response content based on knowledge data included in the response (S33), and displays the generated question text string in the suggested keyword area 1021 (S34).

The CPU 2101 then determines whether the displayed suggested keyword is selected (S35). When the suggested keyword is not selected (NO in S35), the CPU 2101 proceeds to the step S30. When the suggested keyword is selected (YES in S35), the CPU 2101 performs screen transition to the screen specified by the URL in the response content indicated by the suggested keyword (S36), and ends the routine.

As such, the user terminal 100 confirms the input text string each time an input is made by the user and sends the confirmed input text string to the information provision server 200, and each time a question text string is supplied from the information provision server 200, the user terminal 100 displays the question text string in a selectable manner. In other words, based on a program provided by the information provision server 200, the user terminal 100 executes a process of confirming the input text string each time an input is made by the user and sending the confirmed input text string to the information provision server 200, and displaying a question text string in a selectable manner each time the question text string is supplied from the information provision server 200. To put it differently, the information providing system 1 includes the user terminal 100 and the information provision server 200, and executes a process of confirming the input text string each time an input is made by the user and sending the confirmed input text string to the information provision server 200, and displaying a question text string in a selectable manner each time the question text string is supplied from the information provision server 200.

As described above, because the user terminal 100 displays a question text string in real time and in a selectable manner each time an input is made by the user, it is possible to do away with a process of performing search and selecting a question text string, each time an input text string is updated.

### (Modification 2)

In the embodiment above, as shown in FIG. 1, an input text string is confirmed as the search button 1011 is pressed. In a modification below, a text string for input conversion, which corresponds to each of the synonyms, is stored in the synonym dictionary database 400 in association with a representative term. This modification encompasses the arrangements of the above-described modification 1. The modification, however, is not limited to this configuration.

Examples of a text string for input conversion include “Yomigana” that specifies a term by a combination of alphabets for text input when the synonym is written in Chinese characters, and a combination of alphabets for specifying “Yomigana”. Because such a text string for input conversion is stored in the synonym dictionary, it becomes more likely to acquire a response content desired by the user only by specifying “Yomigana” or alphabets of a part of the synonym as an input text string.

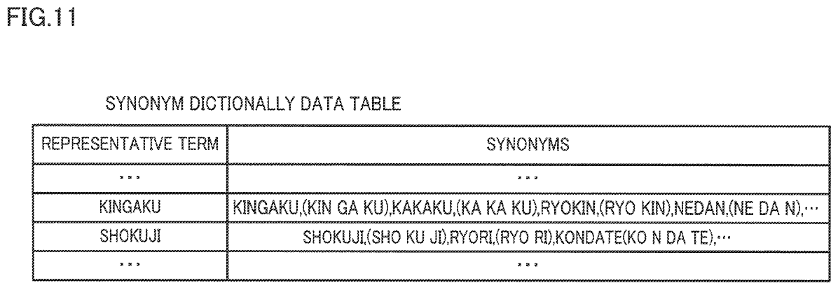

For example, as shown in FIG. 11, sets of Yomigana are registered in a synonym dictionary data table of a synonym dictionary database 400 of this modification, in addition to synonyms. While in the modification a text string for input conversion is registered as each of synonyms, the disclosure is not limited to this arrangement.

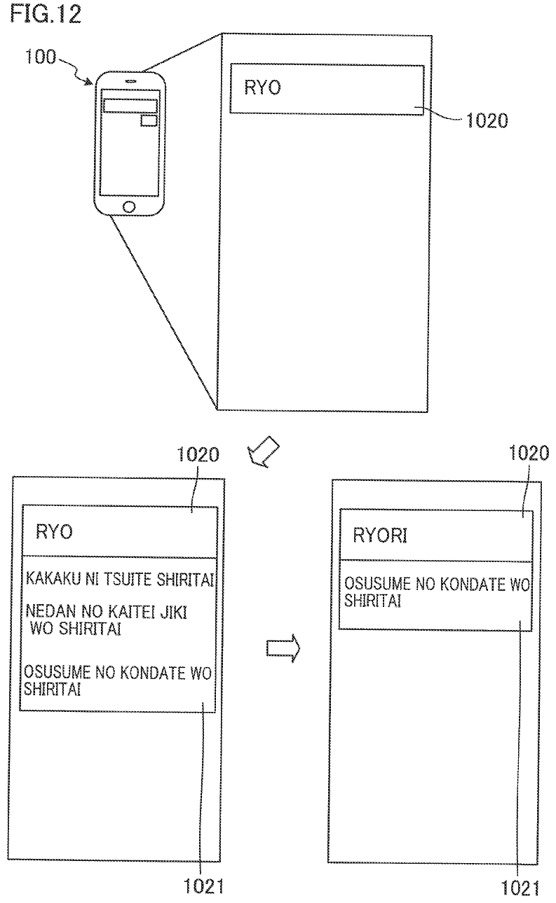

As shown in FIG. 12, when the user inputs “Ryo” in the input area 1020, “Ryo” is sent to the information provision server 200 as an input text string. With reference to the synonym dictionary data table (see FIG. 11), the information provision server 200 selects “Ryokin (price)” and “Ryori (food)” from the synonym column, searches the suggestion database 500 by using, as a search text string, representative terms “Kingaku (cost)” and “Shokuji (food)” corresponding to the selected terms, and sends a question text string corresponding to a selected normalized text string to the user terminal 100. With this arrangement, the question text string including “Kingaku” and “Shokuji” as targets of search is displayed in the suggested keyword area 1021.

As shown in FIG. 12, when the user inputs “Ryori” in the input area 1020, “Ryo” is sent to the information provision server 200 as an input text string. With reference to the synonym dictionary data table (see FIG. 11), the information provision server 200 selects “Ryori” from the synonym column, searches the suggestion database 500 by using, as a search text string, a representative term “Shokuji” corresponding to the selected term, and sends a question text string corresponding to a selected normalized text string to the user terminal 100. With this arrangement, the question text string including “Shokuji” as a target of search is displayed in the suggested keyword area 1021. For example, a question text string “Osusume No Kondate Wo Shiritai (I want to get a recommendation for a menu)” is registered in the suggestion database 500. As a normalized text string corresponding to this text string, a normalized text string “Osusume No Shokuji Wo Shiritai (I want to know a recommended food)” is registered in the suggestion database 500. This normalized text string “I want to know a recommended food” is found by search, and the question text string “I want to get a recommendation for a menu” corresponding to the normalized text string is sent to the user terminal 100.

The detailed description above is mainly focused on characteristics of the present invention to for the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

### REFERENCE SIGNS LIST

1 information providing system
100 user terminal
200 information provision server
300 knowledge database
400 synonym dictionary database
500 suggestion database
700 network

1. An information providing system comprising:
a knowledge data storage unit which is configured to store a question text string associated with a response content;
a synonym storage unit which is configured to store a synonym dictionary in which synonyms that are similar to one another in definition are set;
a receiver which is configured to receive an input text string input by a user by using a user terminal;
a search unit which is configured to generate a search text string by converting a term included in the input text string based on the synonym dictionary, so as to specify the question text string related to the search text string; and
a transmitter which is configured to send the specified question text string to the user terminal.

2. The information providing system according to claim 1, wherein,
in the synonym dictionary, one of the synonyms is set as a representative term,
the knowledge data storage unit stores the question text string and a normalized text string generated by converting a term included in the question text string into a representative term based on the synonym dictionary, in association with each other,
the search unit generates a search text string by converting a term included in the input text string into a representative term based on the synonym dictionary, and
the search unit selects the normalized text string by using the search text string, so as to specify the question text string corresponding to the selected normalized text string.

3. The information providing system according to claim 1, wherein,
the user terminal confirms the input text string and sends the confirmed input text string to the receiver, each time an input is made by the user, and
the user terminal presents the question text string in a selectable manner, each time the question text string is supplied from the transmitter.

4. The information providing system according to claim 1, wherein, in association with the representative term, the knowledge data storage unit stores a text string for input conversion, which corresponds to each of the synonyms.

5. An information provision control method executed by a computer including a storage unit, the method comprising the steps of:
storing a question text string associated with a response content;
storing a synonym dictionary in which synonyms that are similar to one another in definition are set;
receiving an input text string input by a user by using a user terminal;
generating a search text string by converting a term included in the input text string based on the synonym dictionary, so as to specify the question text string related to the search text string; and
sending the specified question text string to the user terminal.

6. A data structure of knowledge data, which is used by a computer including a control unit accessible to a synonym storage unit storing a synonym dictionary in which synonyms that are similar to one another in definition are set, and is stored in a storage unit of the computer,
the data structure including a structure in which a question text string is associated with a response content, and
in regard to an input text string input by a user by using a user terminal, the control unit generating a search text string by converting a term included in an input text string based on the synonym dictionary, and specifying a question text string related to the search text string.
